(19) United States
(12) Patent Application Publication
(10) Pub. No.: US 2011/0231231 A1
(43) Pub. Date: Sep. 22, 2011

(54) MINIATURE BILLBOARD ADVERTISEMENTS

(76) Inventor: Arnaldo Zael Cruz, Miami, FL (US)

(21) Appl. No.: 12/725,201

(22) Filed: Mar. 16, 2010

(51) Int. Cl. G06Q 30/00

(52) U.S. Cl. 705/14.4

(57) ABSTRACT

Street-level advertising billboards may offer advertisers an additional method to reach consumers, either while they are driving or walking through city streets. The billboards may be located on stoplights, walk/don't walk signs, or the like. The billboards may include an electronic display panel for displaying an advertisement, a network interface for wirelessly sending collected data to and receiving advertisement display data from the advertisement system, and a sensor for collecting external data.

### BACKGROUND OF THE INVENTION

The present invention relates to miniature billboards and, more particularly, to miniature billboards, placed at traffic lights, traffic poles and walk/don't walk signs, capable of tracking advertisement reach, recording advertisement demographics, and capturing photographs.

Advertisements are often placed outdoors in high traffic areas, such along the sides of interstate highways. Modern advertisements may be electronically displayed on large video displays. There are, however, no ways to track the amount of traffic the advertisements may reach. In addition, interstate highway billboards may not be effective at a city street level. City streets typically do not offer areas to post billboards.

As can be seen, there is a need for miniature billboards that may provide street-level advertisement. There is a further need for a billboard effectiveness monitoring system, allowing advertisers to appreciate the reach of their advertisement.

### SUMMARY OF THE INVENTION

In one aspect of the present invention, a street-level advertisement system comprises an electronic display panel for displaying an advertisement; a network interface for wirelessly sending collected data to and receiving advertisement display data from the advertisement system; and a sensor for collecting external data.

In another aspect of the present invention, a street-level advertisement system comprises a housing comprising an electronic display panel for displaying an advertisement; a network interface for wirelessly sending collected data to and receiving advertisement display data from the advertisement system; and a memory for storing advertisements; a sensor attached to the housing for collecting external data; and a solar panel array attached to a top portion of the housing for providing power to the advertisement system.

These and other features, aspects and advantages of the present invention will become better understood with reference to the following drawings, description and claims.

### BRIEF DESCRIPTION OF THE DRAWINGS

FIG. 1 is a perspective view of a street-level billboard attached to a stop light, according to an embodiment of the present invention;

FIG. 2 is a perspective view of a street-level billboard attached to a walk/don't walk sign, according to an embodiment of the present invention;

FIG. 3 is a perspective view of a street-level billboard attached to stop light wires, according to an embodiment of the present invention; and

FIG. 4 is a detail side view of the billboard of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides street-level advertising billboards. The billboards may offer advertisers an additional method to reach consumers, either while they are driving or walking through city streets. The billboards may be located on stoplights, walk/don't walk signs, or the like.

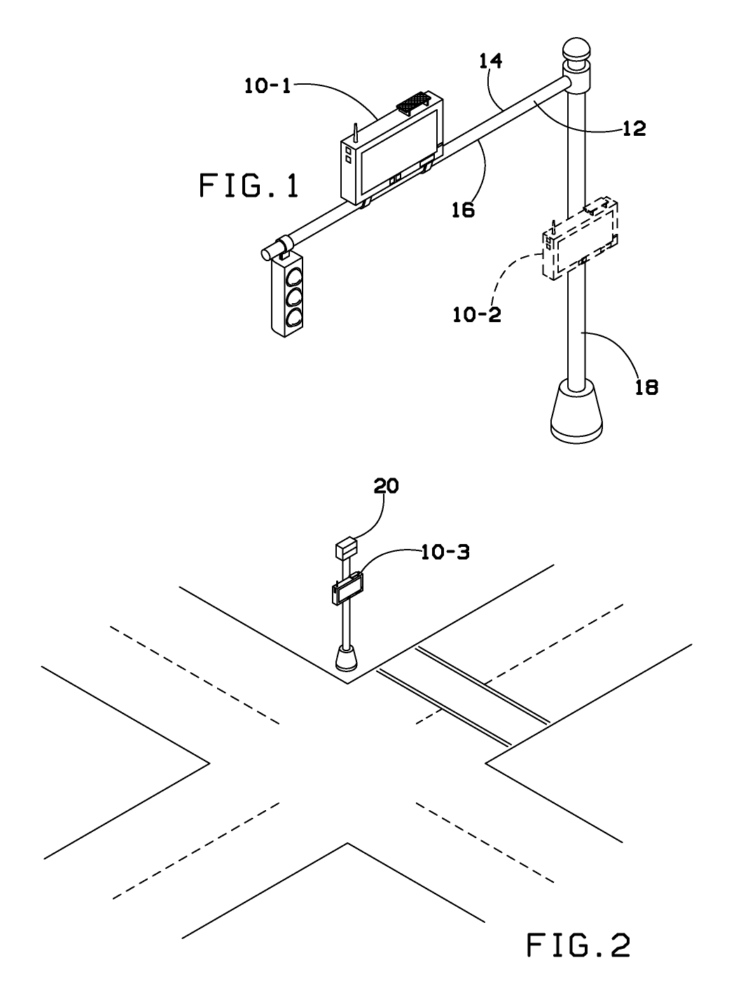

Referring to FIG. 1, there is shown a perspective view of a street-level billboard 10-1 attached to a stop light arm 12, according to an embodiment of the present invention. The billboard 10-1 may be located on a top side 14 of the stop light arm 12, as shown in FIG. 1, or, alternatively, on a bottom side 16 of the stop light arm 12. In another embodiment of the present invention, a billboard 10-2 may be located on a stop light post 18.

Referring to FIG. 2, there is shown a perspective view of a street-level billboard 10-3 attached to a walk/don't walk sign 20. With the stop light post 18 mount of FIG. 1, or the walk/don't walk sign 20 mount of FIG. 2, the billboard 10-2, 10-3 may be located at or near the eye level of a typical pedestrian.

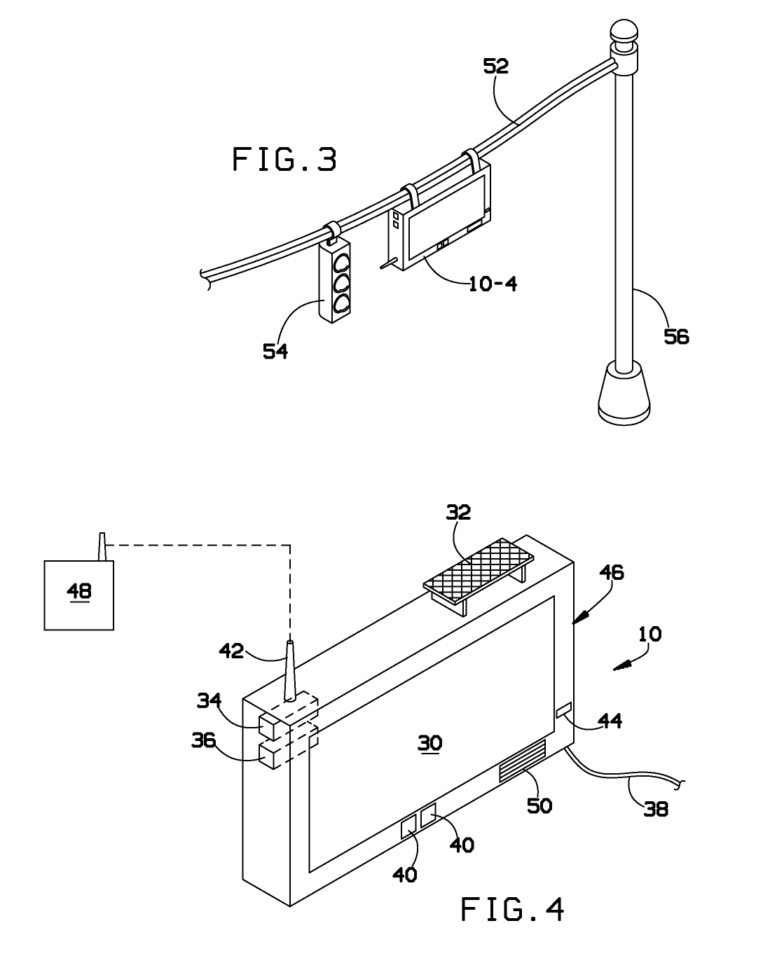

Referring to FIG. 3, there is shown a perspective view of a street-level billboard 10-4 attached to existing wires 52 that power a stop light 54. The wires 52 may run between poles 56. Power for the billboard 10-4 may be gained from the wires 52, or, as discussed below, a solar panel (FIG. 4).

Referring to FIG. 4, there is shown a detail side view of a billboard 10 that may be used as the street-level billboard 10-1, 10-2, 10-3 according to exemplary embodiments of the present invention. The billboard 10 may include an electronic display panel 30, such as a liquid crystal display (LCD) that may display an advertisement. The billboard 10 may include a conventional 3D exposure video imaging system. The billboard 10 may display in any video resolution, such as high definition, for example. The billboard 10 may also include a solar panel array 32 which may provide power to the electronic display panel 30 and other electronic components of the billboard 10. The billboard 10 may further include a power cable 38 that may be used to provide additional power, such as AC or DC power, to the billboard 10.

The billboard 10 may include a network interface 34, such as an addressable network router, that a user may utilize to deliver programming information into a memory 36 of the billboard 10. For example, a user may access an internet address to deliver programming information to or retrieve data from the billboard 10. The network interface may include an antenna 42 for sending and receiving data. Data may also be sent to and from the billboard 10 via an external data port 44, such as a conventional USB port.

The billboard 10 may include one or more external sensors 40 to collect data. The sensor may collect data such as number of people or animals (such as pets) within a certain distance, such as a typical viewing distance, of the billboard, the types and/or number of vehicles passing under the billboard, the time of day, the weather, and the like. One or more of the sensors 40 may include a camera for taking photographs around the location of the billboard. The photographs may be stored in the memory 36 and sent from the billboard via the network interface 34. Photographs may be taken, for example, during playback of a advertisement as a research tool to determine whether the advertisement captures the attention of viewers and what demographic of viewers may stop to view the advertisement.

In one embodiment, the sensor 40 may collect data and the display panel 30 may alter the display based on the collected data. For example, the sensor 40 may collect weather data and the display panel 30 may display an advertisement for an umbrella when it's raining. In another embodiment, the sensor 40 may collect data concerning the types of vehicles passing under the billboard 10. In this embodiment, the display panel 30 may display an advertisement for truck repair if a relatively large number of trucks are detected. In another embodiment, the display panel 30 may display a pet product advertisement if the sensor detects a relatively large number of animals within a vicinity of the billboard 10.

In another embodiment of the present invention, the sensor 40 may collect demographic data such as the number of people within a certain distance of the billboard 10, the types of vehicles passing under the billboard, the speed of people passing under the billboard, whether people stop to view the advertisement, and the like. Advertising companies may use this collected data to determine the type of advertisements to be presented, the time of day to present certain advertisements, and the fees to charge based on the anticipated reach of the advertisement at a given time and location.

The billboard 10 may include one or more speakers 50. The advertisements displayed on the billboard 10 may include sound to be delivered to advertisement viewers via the speakers 50. Typically, billboards 10 with speakers 50 may be placed at walk/don't walk signs, for example.

The billboard 10 may include a housing 46 for encasing the display device 30, the network interface 34, the memory 36 and other weather sensitive components. The housing 46 may be weather resistant, such as water proof. The housing 46 may also protect the components of the billboard 10 from damage due to vandalism or unintentional damage.

The billboard 10 may include a remote management station 48 for remotely controlling the advertisements displayed on the billboard 10, for receiving data collected by the sensor 40, and for interfacing with the network interface 34. The remote management station 48 may communicate via conventional wireless protocols with the billboard 10, for example, via network interface 34.

While the billboard has been described as being located at intersections, other placement locations may be considered. For example, the billboard 10 may be positioned at toll booths or parking garages to provide directed advertising to a specific market.

It should be understood, of course, that the foregoing relates to exemplary embodiments of the invention and that modifications may be made without departing from the spirit and scope of the invention as set forth in the following claims.

I claim:

1. A street-level advertisement system comprising:
an electronic display panel for displaying an advertisement;
a network interface for wirelessly sending collected data to and receiving advertisement display data from the advertisement system; and
at least one sensor for collecting external data.

2. The advertisement system of claim 1, wherein the external data includes at least one of demographic data, weather data, time of day data, and photographs.

3. The advertisement system of claim 1, wherein the external data determines the content of the advertisement displayed.

4. The advertisement system of claim 1, further comprising a memory for storing advertisements.

5. The advertisement system of claim 1, further comprising a solar panel array for providing power to the advertisement system.

6. The advertisement system of claim 1, further comprising at least one speaker for transmitting sound associated with the advertisements.

7. The advertisement system of claim 1, further comprising a central station for remotely managing the advertisements and receiving the collected data.

8. The advertisement system of claim 1, further comprising an external power cable for providing one of AC or DC power to the advertisement system.

9. The advertisement system of claim 1, wherein at least one display panel is attached to at least one of a traffic stop light arm, a traffic stop light pole, a toll booth plaza, a parking garage, and a walk/don't walk sign.

10. A street-level advertisement system comprising:
a housing comprising:
an electronic display panel for displaying an advertisement;
a network interface for wirelessly sending collected data to and receiving advertisement display data from the advertisement system; and
a memory for storing advertisements;
a sensor attached to the housing for collecting external data; and
a solar panel array attached to a top portion of the housing for providing power to the advertisement system.
